(19) United States
(12) Patent Application Publication
(10) Pub. No.: US 2009/0246727 A1
(43) Pub. Date: Oct. 1, 2009

(54) PHANTOM

(76) Inventors: Lorenzo Vanini, San Fedele Intelvi (IT); Mario Testoni, Lellarengo/Asti (IT); Leonardo Dondelli, Botticino/Brescia (IT)

Correspondence Address: RANKIN, HILL & CLARK LLP, 38210 Glenn Avenue, WILLOUGHBY, OH, 44094-7808, US

(21) Appl. No.: 12/067,595

(22) PCT Filed: Sep. 20, 2006
(86) PCT No.: PCT/IB06/02611

§ 371 Date: Jun. 17, 2008

(30) Foreign Application Priority Data
Sep. 21, 2005 (CH) 01542/05

(51) Int. Cl. A61C 19/10

(52) U.S. Cl. 433/26

(57) ABSTRACT

The referencing or calibration phantom (1) has at least a partial surface with at least two different colors or two shades of the same color The surface is at least partially opaque.

This invention concerns a phantom according to the preamble of claim 1 and its use for referencing or calibrating color digital images in the field of reconstruction of teeth. The use of the phantom is not restricted to the field of the dentist but includes dentistry in general, odontology and any other dental application, that is used in clinics and laboratories.

In the years following 1930 Bruce Clark introduced the Munsell (a painter of 1898) color system into dentistry. Munsell's system considers three color dimensions:
Hue: basic teeth color coming from the internal dental body;
Value: The intensity of the hue and it defines its degree of saturation or purity;
Chroma: defines the degree of color luminosity

However, in practice this kind of color definition, borrowed from painting and applied through color scales to the dental profession, proved to be full of defects, inaccuracies and incompleteness. The weakness of this theory when determining the color of the teeth was pointed out by various writers over the years. E. B. Clark in 1931 stated “we are not ready to solve the color problem”; P. A. Le Mire in 1979 argued that “choosing and determining color were still rooted to the last century”. G. Preston in 1985 asserted: “usually the colors of the prosthesis' are established through a color scale, however the use of such means has turned out to be frustrating and of little satisfaction”.

Almost 80 years later the problem still exists, since dentists still use the Munsell color system as a point of reference and continue using the commercial colors directly into the patient's mouth as it used to be done in the past.

This is the problem this invention aims to resolve.

The invention takes into account the new conception of color in dentistry according to Lorenzo Vanini's color system (“Conservative restoration of anterior teeth” Vanini, Mangani, Klimovskaia, ACME Viterbo, 2003) where 5 color dimensions are taken into account and thus no longer the four A B C D hues of the life system but only one hue that is also the universal hue (UD, Universal Dentin).

This system, correlated by a color chart with numbers, letters and classifications allows a better documentation and communication of color in dentistry.

Starting from this new color system the invention offers the possibility to clinically establish the color of a tooth by using the patient's digital images, a virtual color scale and a database containing sample images of natural healthy teeth, classified according to an age biotype (child, adult, elderly person). Each sample of the database is developed in laboratory with composite material and the database contains its images.

However, the invention is not restricted only to the use of a special type of reconstruction material or a particular brand of such materials. The invention can be applied on all kinds of reconstruction material and on all techniques either in a dentist's clinic or in a dentistry laboratory. However, further ahead the invention shall be described in detail using Lorenzo Vanini's color system. For other color systems or other reconstruction materials the art man can easily adapt the technique.

The invention solves the main problem of obtaining an equal and balanced image of the tooth in question in terms of dimension and photographic parameters, compared to the virtual color scale images and to the teeth contained in the database.

The invention solves the proposed task with a multicolor phantom according to the characteristics of claim 1.

Once loaded into the computer, the patient's digital image (with the reference phantom), can be analyzed by a suitable software. To balance the image obtained according to the method according to invention, a phantom is required. Once positioned in the patient's mouth within the range of the photo, the phantom feeds the software with the information required to compare and balance the image with the samples of the color scale and database.

The phantom according to the invention may have any shape, e.g. it can be shaped like small colored stamps with the following characteristics: the shape may be round, elliptic, rectangular, and squared or any other shape depending on the positioning in the patient's mouth. For a round shape, a diameter of 5-6 mm, at most 10 mm, and approximately a 1 mm thickness will be most appropriate. The phantom may preferably exhibit at least three colors on its surface. Further the phantom is preferably a disposable object that can be supplied to the dentist in a sterile package.

The image taken by means of photo camera in the mouth of the patient which comprises a digital image of a) the tooth in question, b) of said phantom and c) of the nearest healthy tooth can be transferred from the camera to the computer where the software carries out an automatic dimension, color and luminosity balancing to compensate any difference between the image and the samples used.

The software can carry out a dimensions and color analysis in RGB (Red, Green and Blue). Thanks to the phantom according to the invention, which comprises and supplies fixed reference values, the software compares the data in the RGB image imported to the ones of the virtual color scale of the database balancing their values automatically. In this way, any errors due to the use of the system (e.g. camera-light) and different photographic settings can be eliminated.

Thanks to information to be found on the phantom, a more accurate measurement of the color per zones can be carried out on the image balanced by the software. Measuring of the middle third coronal can be used for automatic establishment of the chromaticity, the first color dimension in Lorenzo Vanini's color system. The RGB values of the third middle coronal can be compared to the values of the color scale measured in RGB with a repeatable standardized technique. The software is capable of choosing the dentine sample of the virtual color scale closest, as value of the RGB, to the value of the third middle of the tooth in question, which will be the real basic chromaticity. Still on the third middle, the value to be compared with the coating samples of the virtual color scale (GE1, GE2, GE3) is measured. Regarding other color dimensions (intensives, opalescence, and characterizations) it is possible to measure the zones in question (white spot, stains, incisal or interproximal opalescence, characterization of the incisal margin, cracks) and compare the measurements with the values of the samples of the masses present in the color scale that are used to develop these dimensions (OW, IW, IM, OBN, OA). Regarding terms used and the basic color system reference is made to Lorenzo Vanini, “Conservative restoration of anterior teeth” Vanini, Mangani, Klimovskaia, ACME Viterbo, 2003.

Once the color has been established and the masses chosen, by means of the virtual color scale, the image is compared to the sample images of the database where the software supplies the most similar or compatible biotypes according to the mean analysis of the data concerning shape, dimension and color. The dentist can see the comparisons on the computer's monitor wherein alongside the image of the chosen sample tooth, there will be exhibited similarity percentages, concerning shape, dimension and color, with the tooth in question. The dentist can choose the most appropriate solution among the ones proposed by the software, evaluating both the aspect and the numerical percentages. Once the ideal tooth has been selected from the database, all the reconstruction stages to prepare, with the composite materials, the chosen element correctly and in the most natural way can be visualized. As a matter of fact, all the teeth in the database are developed in the laboratory and the software contains the photographic documentation of the operation stages (mass stratification, finishing and polishing). In this way, not only the clinician will have information concerning the establishment of the color but also and above all suggestions and precious information to create the correct integration of shape and color during the restoration.

An illustrative use (but not in a limiting sense) of the phantom according to the invention is schematically described step by stem as follows:

1. The phantom is positioned in the patient's mouth near the tooth to be reconstructed (tooth in question) on the gums, preferably between the tooth in question and the nearest healthy tooth, within the range of the photograph to be taken.

2. With a good quality camera allowing to obtain a real color depth of 24 bits divided into 8 bits per each fundamental color component (RGB: red/green/blue) a digital image of the tooth in question, the phantom and the nearest healthy tooth (real image) is developed. The phantom contains and supplies fixed reference values.

3. The real image obtained in step 2 is transferred to a computer for analysis. The computer is equipped with a collection of healthy teeth digital images (database) with an ideal phantom. The phantom is produced using a procedure guaranteeing repeatability of reproduction with time. The measure of the colors composing the phantom is known to the software. This measure is repeated per sample in a specialized laboratory. This measure guarantees a level of light and a constant acquisition system with time. In case the constructive techniques of the phantom are modified with time, the software can use its own internal procedure to recalibrate the calculations according to the new phantom model.

4. The software is capable of converting the real image (with the real phantom) into an ideal image (with the ideal phantom stored in the computer). $

5. The software analyses the healthy tooth of the ideal image mentioned in step 4 in terms of shape, dimension and color and searches for the most matching tooth in the database. For a better matching, this data comparison can also be carried out on partial zones of the tooth. The third middle coronal of the tooth for instance.

6. According to the most similar tooth found by the computer software, the dentist obtains all the information required to carry out the reconstruction of the tooth, especially the kind of reconstruction material to be used (the color of the artificial dentine material/the thickness of the artificial dentine/the color of the artificial coating material/the thickness of the artificial coating material). The software can also video-simulate the final result to be shown to the patient. Even the final result can be calculated using the phantom calibration.

The number of zones on the surface of the phantom may vary, for example between 3 and 10. At least two colors or at least two shades of one color are required to obtain a useful referencing or calibration. The surface of the colored zones (or of the color shades) must be opaque or non-transparent to avoid reflections.

In a special embodiment the phantom 1 is provided with three zones 3,4,5 one of which has the red color (R), the other has a blue color (B) whereas the third one has a green color (G). Additional colors or zones of the same color (R,G,B) can be added and also one or more zones of a fourth color, white for instance, can be added.

The phantom 1 may be rectangular or round shaped with an upper surface 2 with the zones (3,4,5,8) bearing a different color and a lower surface 6 meant to get into contact with the gums or with the tooth.

In another embodiment the lower surface 6 of the phantom 1 has an adhesive material 7, preferably activated by contact with saliva. Otherwise the phantom can be produced even without an adhesive surface and its positioning in the mouth could be guaranteed by the saliva.

In another embodiment the lower surface 2 has at least four zones (3,4,5,8) colored differently.

In still another embodiment the upper surface 2 has various zones ranging between 3 and 10, and various colors ranging from 3-5.

The detailed description shall be understood better with help from the drawings attached, in which the same reference characters represent the same elements, as follows:

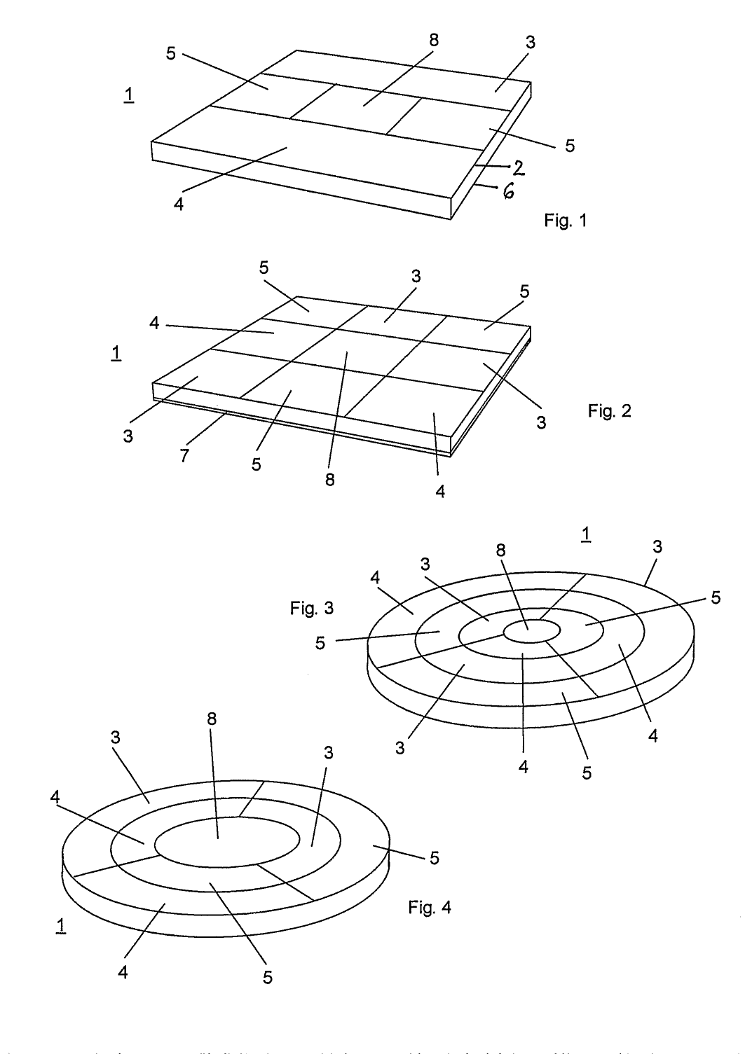

FIG. 1 is a perspective drawing of an illustrative mode of realization of a phantom according to the invention;

FIG. 2 is a perspective drawing of a second illustrative mode of realization of a phantom according to the invention;

FIG. 3 is a perspective drawing of a third illustrative mode of realization of a phantom according to the invention; and

FIG. 4 is a perspective drawing of a fourth illustrative mode of realization of a phantom according to the invention.

FIG. 1 shows a rectangular shaped phantom 1 with five zones 3,4,5,5,8. Of which one has a red (R;3) surface, another one has a blue (B;4) surface, two others have a green colored surface (G;5) and whereas the last one has a white surface (W;8).

FIG. 2 shows an alternative rectangular shaped phantom 1 but with nine zones 3,3,3,4,4,5,5,5,8 of which three have a red surface (R;3), two others have a blue surface (B;4), three others have a green colored surface (G;5) and whereas the last one has a white colored surface (W;8).

FIG. 3 shows an alternative round disc shaped phantom 1 with seven zones 3,3,4,4,5,5,8 of which two have a red surface (R;3), two others have a blue surface (B;4), two others have a green colored surface (G;5) and whereas the last one has a white surface (W;8).

FIG. 4 shows an alternative round disc shaped phantom 1 but with ten zones 3,3,3,4,4,4,5,5,5,8 of which three have the red surface (R;3), three others have a blue surface (B;4), three others have a green colored surface (G;5) and whereas the last one has a white colored surface (W;8). The white colored zone 8 is located at the centre of the phantom 1. Around the white zone 8 the other zones are distributed in annular circles in a way that each circle has three sectorial zones of different colors, that is red, blue and green.

1. A referencing or calibration phantom (1) wherein
A) the phantom (1) has at least a partial surface with at least two different colors or two shades of one color; and
B) said at least partial surface is at least partially opaque.

2. The phantom (1) according to claim 1, wherein said at least partial surface has at least three zones (3,4,5) with different colors (R;B;G).

3. The phantom (1) according claim 2, wherein said three zones (3,4,5) are colored in red (R), blue (B) and green (G).

4. The phantom (1) according to claim 1, wherein the shape of said phantom (1) is plate-like or disk-like.

5. The phantom (1) according to claim 3, wherein said phantom (1) has an upper surface (2) with said three zones (3,4,5) colored differently and a lower surface (6) adapted to get into contact with the gums or with the tooth.

6. The phantom (1) according to claim 5, wherein said lower surface (6) is provided with an adhesive material (7) preferably activated by the contact with saliva.

7. The phantom (1) according to claim 1, wherein said at least partial surface is provided with at least four zones (3,4,5,8) colored differently.

8. The phantom (1) according to claim 1, wherein said phantom (1) is provided with a number of zones ranging between three and ten having different colors.

9. The phantom (1) according to claim 8, wherein the number of said different colors is between three to five.

10. The phantom (1) according to claim 1, wherein said at least partial surface is flat and smooth.

11. The phantom (1) according to claim 1, wherein the phantom is adapted to reference or calibrate colored digital images in the field of reconstruction of teeth.

12. A method for obtaining information for reconstructing a tooth, comprising the steps of:
A) positioning a reference or calibration phantom in a patient's mouth near the tooth to be reconstructed within a range of a photograph to be taken;
B) taking a digital image of a) the tooth in question, b) of said phantom (1) and c) of a nearest healthy tooth by means of photo camera, thereby producing a real image;
C) transferring the real image obtained in step B to a computer for analysis, said computer being provided with
a) a collection of digital images showing healthy teeth (database) together with an ideal phantom; and
b) a software capable of converting said real image (with the real phantom) into an ideal image (with the ideal phantom stored in said computer).
D) analyzing the healthy tooth of said ideal image obtained in step C) regarding its shape, dimension and color and retrieves in the database a healthy tooth matching best;
E) according to a most matching tooth found in step D, the computer provides the information required to carry out the reconstruction of the tooth either in a clinic or in a laboratory.

13. The phantom (1) according to claim 2, wherein the shape of said phantom (1) is plate-like or disk-like.

14. The phantom (1) according to claim 13, wherein said phantom (1) has an upper surface (2) with said three zones (3,4,5) colored differently and a lower surface (6) adapted to get into contact with the gums or with the tooth.

15. The phantom (1) according to claim 14, wherein said lower surface (6) is provided with an adhesive material (7) preferably activated by the contact with saliva.

16. The phantom (1) according to claim 3, wherein the shape of said phantom (1) is plate-like or disk-like.

17. The phantom (1) according to claim 16, wherein said phantom (1) has an upper surface (2) with said three zones (3,4,5) colored differently and a lower surface (6) adapted to get into contact with the gums or with the tooth.

18. The phantom (1) according to claim 17, wherein said lower surface (6) is provided with an adhesive material (7) preferably activated by the contact with saliva.
